(19) United States
(12) Patent Application Publication
(10) Pub. No.: US 2016/0158691 A1
(43) Pub. Date: Jun. 9, 2016

(54) METHOD OF GAS CAPTURE

(71) Applicants: Pavel Kortunov, Flemington, NJ (US); Michael Siskin, Westfield, NJ (US)

(72) Inventors: Pavel Kortunov, Flemington, NJ (US); Michael Siskin, Westfield, NJ (US)

(73) Assignee: ExxonMobil Research and Engineering Company, Annandale, NJ (US)

(21) Appl. No.: 14/936,897

(22) Filed: Nov. 10, 2015

Related U.S. Application Data
(60) Provisional application No. 62/087,465, filed on Dec. 4, 2014.

(51) Int. Cl. B01D 53/14

(52) U.S. Cl. CPC B01D 53/1493; B01D 53/1475; B01D 2252/20473; B01D 2252/20431

(57) ABSTRACT

Methods for separating carbon dioxide from a gas stream are described. The methods include (a) providing a stream having a gas therein; and (b) contacting the stream with a sorption composition thereby removing at least a portion of the gas from the stream. The sorption composition includes a solid support, a linking moiety, and a gas-capture moiety or a reaction product thereof; wherein the gas-capture moiety has a formula according to Formula (I):

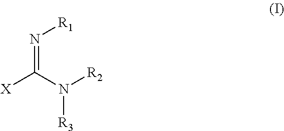

wherein R₁ to R₃ may be the same or different and are selected from H or hydrocarbyl (e.g., selected from the group consisting of substituted or unsubstituted, branched or linear C₁-C₂₀ alkyl groups and substituted or unsubstituted, branched or linear C₁-C₂₀ alkenyl groups);
wherein X is selected from the group consisting of H, hydrocarbyl groups, and amino and alkylamino groups,

### CROSS-REFERENCE TO RELATED APPLICATIONS

This application claims priority to U.S. Provisional Application Ser. No. 62/087,465 filed Dec. 4, 2014, herein incorporated by reference in its entirety.

### FIELD OF INVENTION

The invention relates to methods of gas-capture using supported gas-capture moieties selected from guanidines, biguanides, amidines and compounds derived therefrom.

### BACKGROUND OF INVENTION

The removal of undesirable gases from mixed gas streams is of great industrial importance and commercial value. For example, carbon dioxide is a ubiquitous and inescapable by-product of the combustion of hydrocarbons and there is growing concern over its accumulation in the atmosphere and its potential role in global climate change. Regulatory trends driven by environmental factors suggest that capture and sequestration of such gases may be required. Existing methods of gas capture have been satisfactory for the scale in which they have so far been used. Future uses on a far larger scale, however, will be required for significant reductions in atmospheric emissions, particularly of CO₂, from major stationary combustion sources, such as power stations fired by fossil fuels. Thus, improvement in the energy efficiency of the processes used for the removal of undesirable gases process mixtures would beneficially lower overall process cost, particularly the cost of CO₂ capture.

Cyclic CO₂ sorption technologies such as Pressure Swing Absorption (PSA) and Temperature Swing Absorption (TSA) using liquid sorbents are well-established. The sorbents mostly used include liquid solvents, as in amine scrubbing processes, although solid sorbents are also used in PSA and TSA processes. Liquid amine sorbents dissolved in water are probably the most common sorbents. Amine scrubbing is based on the chemical reaction of CO₂ with amines to generate carbonate/bicarbonate and carbamate salts—the aqueous amine solutions chemically react with the CO₂ by the formation of one or more ammonium salts, such as carbamate, bicarbonate, and carbonate. The reaction tends to be reversible, and these salts can be converted back to the original components upon suitable adjustment of conditions, usually temperature, enabling the regeneration of the free amine at moderately elevated temperatures. Commercially, amine scrubbing typically involves contacting the acid gas (CO₂ and/or H₂S) containing gas stream with an aqueous solution of one or more simple alkanolamines selected preferentially, as the hydroxyl group confers greater solubility in water for both the amine(s) and for the reaction product(s). Alkanolamines, such as monoethanolamine (MEA), diethanolamine (DEA), and triethanolamine (TEA), as well as a limited set of hindered amines, are currently used in commercial processes. The cyclic sorption process requires high rates of gas-liquid heat exchange, the transfer of large liquid inventories between the sorption and regeneration zones, and high energy requirements for the regeneration of amine solutions. The corrosive nature of amine solutions containing the sorbed CO₂, which forms the amine-CO₂ reaction products, can also be an issue. Without further improvement, these difficulties would limit the economic viability of the aqueous amine scrubbing processes in very large scale applications.

The cyclic sorption processes using aqueous sorbents typically require a significant temperature differential in the gas stream between the sorption and desorption (regeneration) parts of the cycle. In conventional aqueous amine scrubbing methods, relatively low temperatures (e.g., less than 50° C.) are required for CO₂ uptake, with an increase to a temperature above about 100° C. (e.g., 120° C.) required for desorption. The heat required to maintain the thermal differential is a major factor in the cost of the process. With the need to regenerate the solution at temperatures above 100° C., the high latent heat of vaporization of the water (about 2260 kJ/Kg at about 100° C.) obviously makes a significant contribution to the total energy consumption. If CO₂ capture is to be conducted on the larger scale appropriate to use in power plants, more effective and economical separation techniques need to be developed.

### SUMMARY OF INVENTION

Aspects of the invention are based in part on the discovery that certain supported gas-capture moieties selected from guanidines, biguanides, amidines and compounds derived therefrom allow for one or more benefits in the capture of one or more gases, e.g., carbon dioxide, hydrogen sulfide carbonyl sulfide and mercaptans. For example, some such supported compounds act as a strong Lewis base and offer high loading capacity for CO₂ at low partial pressure maintaining high reaction rates. Other compounds offer relatively lower thermal stability, thereby lowering energy necessary for cycling of the capture chemistry. Guanidines and amidines with all tertiary or severely hindered secondary nitrogen atoms act as a very weak Lewis but strong Brønsted bases with low affinity to CO₂ and high affinity to H₂S. Aspects of the invention are based in part on the discovery that such supported gas capture moieties tolerate higher pKa with a reduced amount of undesirable side products.

In one aspect, the invention provides a method for separating carbon dioxide from a gas stream, comprising: (a) providing a stream having a gas therein; and (b) contacting the stream with a sorption composition thereby retaining at least a portion of the gas from the stream, the sorption composition comprising: a solid support, a linking moiety, and a gas-capture moiety or a reaction product thereof; wherein the gas-capture moiety has a formula according to Formula (I):

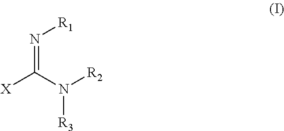

wherein R₁ to R₃ may be the same or different and are selected from H or hydrocarbyl (e.g., selected from the group consisting of substituted or unsubstituted, branched or linear C₁-C₂₀ alkyl groups and substituted or unsubstituted, branched or linear C₁-C₂₀ alkenyl groups); and wherein X is selected from the group consisting of H, hydrocarbyl groups, and amino and alkylamino groups.

### BRIEF DESCRIPTION OF THE DRAWINGS

FIG. 1 schematically illustrates a process for gas capture according to an embodiment of the invention.

FIG. 2 schematically illustrates a sorption composition comprising a gas-capture moiety linked to the surface of a support material according to an embodiment of the invention.

FIG. 3 schematically illustrates Zwitterion formation after exposing an exemplary sorption composition to CO₂ according to an embodiment of the invention.

FIG. 4 depicts the NMR spectra associated with stages of gas-capture and gas recovery by the exemplary gas-capture moiety described in Example 1.

FIG. 5 depicts the NMR spectra associated with stages of gas-capture and gas recovery by the exemplary gas-capture moiety described in Example 2.

FIG. 6 graphically illustrates the H₂S/CO₂ selectivity of 1,1,3,3-tetramethylguanidine (TMG).

### DETAILED DESCRIPTION

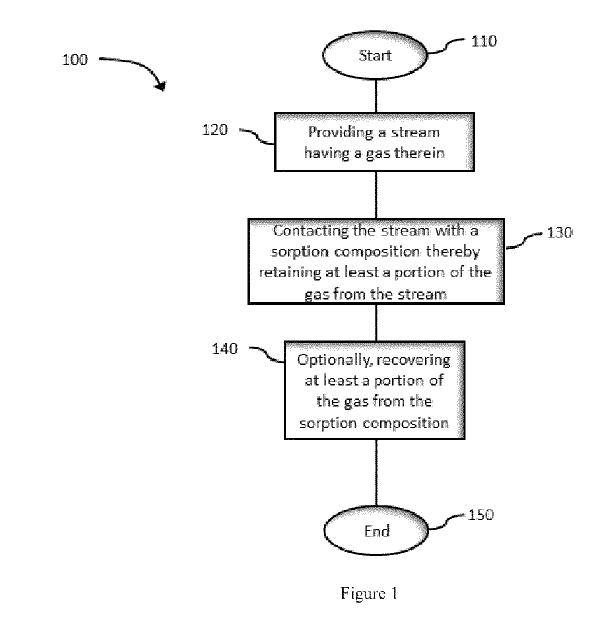

Embodiments of the invention relate to methods for separating one or more gases, e.g. CO₂ and/or H₂S from a gas stream. A particular such process 100 is illustrated in FIG. 1. Process 100 begins at Step 110. Step 110 may include one or more steps that generate a stream having a gas to be removed therefrom. For example, Step 110 may include one or more power production processes in a power plant, one or more chemical or refining processes, or a process providing natural gas from a natural gas source e.g., a pipeline or wellhead, etc. Process 100 continues to Step 120 in which the stream generated in Step 110 and having the gas to be removed is provided, e.g., to a gas-removal unit. In Step 130, the stream is contacted with a sorption composition thereby removing at least a portion of the gas from the stream. The sorption compositions include a gas-capture moiety selected from one or more guanidines, biguanides, and/or amidines and moieties derived therefrom. Mixtures of such compounds and moieties may also be used. The gas capture-moiety is linked, e.g., chemically bound, to a solid support material, typically through a linking moiety. Optionally, the process 100 may include Step 140 wherein at least a portion of the gas may be recovered from the sorption composition, e.g., by regenerating the sorption compounds as described herein. The process 100 concludes at Step 150. Step 150 may comprise one or more additional steps, e.g., providing the stream having a reduced amount of the gas therein resulting from step 130 to one or more further purification processes, refining processes, or chemical manufacturing processes. Additionally or alternatively, Step 150 may include providing the stream from Step 150 for storage or transport.

### Providing a Gas Stream

The stream having a gas, e.g., CO₂, therein may be provided to the gas-removal unit by any convenient method where it is contacted with one or more gas-capture moieties. Gas streams amenable to treatment by the present sorption processes can include, but are not necessarily limited to, flue gas from the combustion of carbonaceous fuels and natural gas, e.g., from subterranean sources. Flue gas streams may originate from the combustion of carbon-containing fossil fuels such as natural gas, lignite coals, sub-bituminous coals, bituminous coals, and anthracite coals. The gas is typically ≧about 3.0 vol %, e.g., ≧about 5.0 vol %, ≧about 7.0 vol %, ≧about 9.0 vol %, ≧about 11.0 vol %, ≧about 13.0 vol %, ≧ or ≧about 15.0 vol % CO₂. The gas content may be ≦about 20.0 vol %, e.g., ≦about 15.0 vol %, ≦about 13.0 vol %, ≦about 11.0 vol %, ≦about 9.0 vol %. ≦about 7.0 vol %, or <about 5.0 vol % CO₂. Exemplary ranges of gas-content of the stream expressly disclosed herein include, but are not limited to, combinations of the above enumerated values, e.g., about 3.0 to about 20.0 vol %, about 3.0 to about 15.0 vol %, about 3.0 to about 11.0 vol %, about 5.0 to about 20.0 vol %, about 5.0 to about 15.0 vol %, about 7.0 to about 15.0 vol %, etc. Typically, streams with the highest levels of, e.g., CO₂, include those resulting from hard coal combustion. Natural gas streams containing CO₂ may contain, in addition to methane and CO₂, one or more other gases such as ethane, propane, n-butane, isobutane, hydrogen, carbon monoxide, ethane, ethyne, propene, nitrogen, oxygen, helium, carbonyl sulfide, hydrogen sulfide, light mercaptans and the like, if they have not been removed by other pre-treatment. Additionally or alternatively, the stream may include H₂S as the gas to be removed. While H₂S may be present in any stream, it is commonly present in natural gas and refinery streams and is less of a concern in flue gas streams.

Additional or alternative streams that can he treated by the present separation process can include syngas and shifted syngas produced in fuel gasification processes, gas streams produced in the manufacture of hydrogen, for example from methane steam reforming, and streams from refinery and petrochemical plants, whose compositions can naturally depend on the process from which they are derived. Water is typically likely to be present both in flue gases from combustion of hydrocarbon fuels or from contact with ground waters and in natural gas.

The pressure of the gas in the stream can vary according to its origin. Natural gas streams can typically be encountered at higher pressures than flue gas streams, and streams from refinery and petrochemical units can vary according to the processing conditions used in the unit. Flue gas streams can typically exhibit roughly atmospheric pressures, which can be as low as about 90.0 kPa (about 13 psi) but the partial pressure of the carbon dioxide in the flue gas stream is typically ≧about 2.0 kPa (≧about 0.29 psi), e.g., ≧about 2.5 kPa (≧about 0.36 psi), ≧about 3.0 kPa (≧about 0.44 psi), ≧about 5.0 kPa (≧about 0.73 psi), ≧about 10.0 kPa (≧about 1.45 psi), ≧about 15.0 kPa (≧about 2.18 psi), or ≧about 25.0 kPa (≧about 3.63 psi). The pressure may be ≦about 25.0 kPa (≦about 3.63 psi), e.g., ≦about 20.0 kPa (≦about 2.90 psi), ≧about 15.0 kPa (≦about 2.18 psi), ≦about 10.0 kPa (≦about 1.45 psi), ≦about 7.5 kPa (≦about 1.11 psi), ≦about 5.0 kPa (≦about 0.73 psi), or ≦about 3.0 kPa (≦about 0.44 psi). Exemplary ranges of gas pressure of the stream expressly disclosed herein include, but are not limited to, combinations of the above enumerated values, e.g., about 2.0 to about 25.0 kPa (about 0.29 to about 3.63 psi), about 2.5 to about 15 kPa (about 0.36 to about 2.18 psi), about 3.0 to about 15.0 kPa (about 0.44 to about 2.18 psi), about 3.0 to about 10.0 kPa (about 0.44 to about 1.45 psi), about 3.0 to about 5.0 kPa (about 0.44 psi to about 0.73 psi), etc. Relatively large amounts of nitrogen from combustion air typically result in relatively low partial pressures of the gas, e.g., CO₂, in the stream (e.g. about 1 vol % CO₂ in N₂ or oxygen-depleted air in the total flue gas at about 100.0 kPa (about 14.5 psi) can result in a CO₂ partial pressure of about 1.0 kPa (about 0.15 psi) in the flue gas; about 10 vol % CO² in N₂ or oxygen-depleted air in the total flue gas at about 100.0 kPa (about 14.5 psi) can result in a CO₂ partial pressure of about 10 kPa (about 1.45 psi) in the flue gas; etc.). The partial pressure of the CO₂ in the sorption zone (tower inlet) can typically be at least about 2.5 kPa (at least about 0.36 psi), and in most cases at least about 3.0 kPa (at least about 0.44 psi).

### Sorption Compositions

Sorption compositions described herein typically include a gas-capture moiety, a solid support and a linking moiety that attaches the gas-capture moiety to the solid support. In particular embodiments, the methods described herein and/or the sorption composition used in the method are essentially free of an amine other than the amidines, guanidines, biguanides, imidazolines described herein. In particular, the methods and sorption compositions are essentially free of a promoter amine. Promoter amines can include nucleophilic amines, such as piperazines and/or piperidines, which can themselves interact (react) more rapidly with CO₂. The more nucleophilic unhindered amine promoters can more rapidly attack CO₂ and can form a zwitterion, a carbamic acid, or a mixed carbamate. For the mixed carbamate, the hindered or tertiary amine can play a role of counterion in forming the mixed carbamate. In the presence of water, the reaction product can hydrate, and CO₂ can he transferred as a bicarbonate anion to the hindered and/or tertiary amine at a faster rate than formation of a bicarbonate via direct CO₂ sorption by the hindered and/or tertiary amine. Amidines, guanidines, biguanides, imidazolines are excluded from the definition of “promotor amine.” Particular promoter amines include a non-hindered primary or secondary amine, an alkanolamine, an aminoether, or a cyclic or acyclic tertiary amine. Promoter amines and their use in gas capture are described in U.S. Pat. Nos. 8,816,078 and 7,938,887, each of which is incorporated herein by reference in its entirety.

As used in this context, the term “essentially free of means that the methods and/or sorption compositions described herein do not intentionally include a promoter amine. Additionally or alternatively, the term means that if a promoter amine is present and/or added, its concentration is that of a trace impurity, e.g., ≦100 ppm, ≦50 ppm, ≦25 ppm, ≦15 ppm, ≦10 ppm, ≦5 ppm, ≦1 ppm, etc.

### Solids Support

The term “solid support” as used herein refers to a composition of matter having a porosity sufficient to retain, physically or chemically, an effective amount of the gas-capture moiety. Exemplary solid support materials include ordered and disordered mesoporous silicate such as MCM and SBA materials, porous carbons, metal organic framework materials (MOF), covalent organic framework materials (COF), porous organic and inorganic framework materials, or a polymer. Particularly useful solid support materials include mesoporous compounds, i.e., mesoporous aluminosilicates and mesoporous silicoaluminophosphates.

The solid support material can employ the rnesoporous compound in its original crystalline form or after formulation into particles, such as by extrusion. A process for producing mesoporous extrudates in the absence of a binder is disclosed in, for example, U.S. Pat. No. 4,582,815, the entire contents of which are incorporated herein by reference.

In particular embodiments, the mesoporous compound may be combined with ≧about 5.0 wt % of a binder, the wt % being based on the total weight of the mesoporous compound and the binder, e.g., ≧about 10.0 wt %, ≧about 15.0 wt %, ≧about 20.0 wt %, ≧about 30.0 wt %, ≧about 40.0 wt %, about 50.0 wt %, or ≧about 60.0 wt %. Additionally or alternately, the binder may be present in an amount of ≦75.0 wt %, based on the weights of the mesoporous compound and the binder, e.g., ≦about 65.0 wt %, ≦about 55.0 wt %, ≦about 45.0 wt %, ≦about 35.0 wt %, ≦about 25.0 wt %, ≦about 20.0 wt %, ≦about 17.5 wt %, ≦about 12.5 wt %, or ≦about 7.5 wt %. Exemplary ranges of binder content of the solid support expressly disclosed herein include, but are not limited to, combinations of the above enumerated values, e.g., about 5.0 to about 75.0 wt %, about 10 to about 65.0 wt %, about 15.0 to about 55.0 wt %, about 20.0 to about 55.0 wt %, about 25.0 to 45.0 wt %, about 30.0 to 45.0 wt %, etc.

There are many different binders that are useful in forming the solid support materials used herein. Non-limiting examples of binders that are useful alone or in combination include various types of metal oxides, e.g., hydrated alumina, silicas, and/or other inorganic oxide sols. One preferred alumina containing sol is aluminum chlorhydrol. Upon heating, the inorganic oxide sol, preferably having a low viscosity, is converted into an inorganic oxide binder component. For example, an alumina sol will convert to an aluminum oxide binder following heat treatment.

Aluminum chlorhydrol, a hydroxylated aluminum-based sol containing a chloride counter ion, has the general formula of AlₘOₙ(OH)ₒClₚ.x(H₂O) wherein m is 1 to 20, n is 1 to 8, o is 5 to 40, p is 2 to 15, and x is 0 to 30. In one embodiment, the binder is Al₁₃O₄(OH)₂₄Cl₇.12(H₂O) as is described in G. M. Wolterman, et al., Stud. Surf. Sci. and Catal., 76, pages 105-144 (1993), incorporated herein by reference in its entirety. In another embodiment, one or more binders are combined with one or more other non-limiting examples of alumina materials such as aluminum oxyhydroxide, boehmite, diaspore, and transitional aluminas such as α-alumina, β-alumina, γ-alumina, δ-alumina, ε-alumina, κ-alumina, and ρ-alumina, aluminum trihydroxide, such as gibbsite, bayerite, nordstrandite, doyelite, and mixtures thereof.

In some embodiments, the binder is an alumina sol, predominantly comprising aluminum oxide, optionally including some silicon. In yet another embodiment, the binder is peptized alumina made by treating an alumina hydrate, such as pseudobohemite, with an acid, preferably an acid that does not contain a halogen, to prepare a sol or aluminum ion solution. Non-limiting examples of commercially available colloidal alumina sols include Nalco 8676 available from Nalco Chemical Co., Naperville, Ill., and Nyacol AL20DW available from Nyacol Nano Technologies, Inc., Ashland, Mass.

Exemplary metal organic framework compositions (MOFs) may also be used. Exemplary MOFs include compositions formed from metals, e.g., Zn, and Cu, and one or more coordinating ligands having two or more coordination sites, e.g., terephthalic acid. On such MOF is MOF-5, formed from Zn and terephthalic acid, which has a Langmuir surface area of about 4400 m²/g. Other MOF's include Zn₄O(BTE)(BPDC), where BTE³⁻=4,4′,4″-[benzene-1,3,5-triyl-tris(ethyne-2,1-diyl)]tribenzoate and BPDC²⁻=biphenyl-4,4′-dicarboxylate (MOF-210). Zn₄O(BBC)₂, where BBC³⁻=4,4 ′,4″-[benzene-1,3,5-triyl-tris(benzene-4,1-diyl)]tribenzoate (MOF-200), Zn₄O(BTB)₂, where BTB³⁻=1,3,5-benzenetribenzoate (MOF-177), e.g., wherein tetrahedral [Zn₄O]⁶⁺ units are linked by large, triangular tricarboxylate ligands. Six diamond-shaped channels (upper) with diameter of 10.8 Å surround a pore containing eclipsed BTB³⁻ moieties. Zn₄O(BDC)₃, where BDC²⁻=1,4-benzenedicarboxylate (MOF-5), Mn₃[(Mn₄Cl)₃(BTT)₈]₂, where H₃BTT=benzene-1,3,5-tris(1H-tetrazole), Cu₃(BTC)₂(H₂O)₃, where H₃BTC=1,3,5-benzenetricarboxylic acid, etc.

Other frameworks suitable for the solid support for the gas-capture moiety include zeolitic imidazolate frameworks (ZIFs) are a class of metal-organic frameworks that are topologically isomorphic with zeolites. ZIFs are composed of tetrahedrally-coordinated transition metal ions (e.g. Fe, Co, Cu, Zn, etc.) connected by organic imidazole linkers. Since the metal-imidazole-metal angle is similar to the 145° Si—O—Si angle in zeolites, ZIFs take on zeolite-like topologies. ZIF structures and compositions are reported in, e.g., Park, et al. (2006), “Exceptional chemical and thermal stability of zeolitic imidazolate frameworks” Pnas 103 (27): 10186-10191; Phan; et al. (2010); “Synthesis, structure, and carbon dioxide capture properties of zeolitic imidazolate frameworks” Ace. Chem. Res. 43 (1): 58-67, each of which is incorporated herein by reference in its entirety. One particularly suitable ZIF may be ZIF-8 (i.e., 2-Methylimidazole zinc salt), having a formula of C₈H₁₂N₄Zn (molecular weight 229.60 g/mol) produced by BASF under the tradename Basolite® Z1200 and available from Sigma-Adrich.

Other frameworks include those referred to as covalent organic frameworks. COFs are another class of porous polymeric materials, consisting of porous, crystalline, covalent bonds that usually have rigid structures, exceptional thermal stabilities (to temperatures up to 600° C.), and low densities. They exhibit permanent porosity with specific surface areas surpassing those of well-known zeolites and porous silicates. Covalent organic frameworks are typically crystalline extended organic structures in which the building blocks are linked by strong covalent bonds. Particular COFs are described in Côté, A. et al.; Porous, Crystalline, Covalent Organic Frameworks, Science. 2005, 310, pp 1166-1170, incorporated herein by reference in its entirety. COF-1 may be particularly useful as a solid support. COF-1 may be formed by the molecular dehydration reaction between boronic acids to form a six-membered B₃O₃ (boroxine) ring structure. Another COF is COF-102.

Other compositions include Polymers of Intrinsic Microporosity. Some such polymers are described in International Scholarly Research Notices, Materials Science, Volume 2012 (2012), Article ID 513986, the disclosure of which is hereby incorporated by reference in its entirety.

Certain mesoporous silicas may also be useful as the solid support. Mesoporous silicas may be synthesized by reacting tetraethyl orthosilicate with a template, e.g., micellar rods. The template can then be removed by washing with a solvent adjusted to the proper pH, as described in Trewyn, et al.; (2007) “Biocompatible mesoporous silica nanoparticles with different morphologies for animal cell membrane penetration” Chemical Engineering Journal 137 (137): 23-29, incorporated herein by reference in its entirety. Mesoporous silicas may also be prepared by sol-gel or spray drying methods as described in A. B. D. Nandiyanto, et al., “Synthesis of Silica Nanoparticles with Nanometer-Size Controllable Mesopores and Outer Diameters” Microporous and Mesoporous Materials 120 (3): 447-453 (2009), which is incorporated herein by reference in its entirety. Exemplary mesoporous silicas include, e.g., MCM-41, MCM-48, SBA-15, MSU-type compositions, KSW-type compositions, FSM-type compositions, and HMM-type compositions, particularly MCM-41, MCM-48, and SBA-15.

### Gas-Capture Moiety

The composition also includes at least one gas-capture moiety, either physically or chemically combined with the solid support material. Certain gas-capture moieties may have a fbrmula according to Formula I:

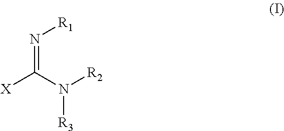

wherein R₁ to R₃ may be the same or different and are selected from H or hydrocarbyl (e.g., selected from the group consisting of substituted or unsubstituted, branched or linear C₁-C₂₀ alkyl groups and substituted or unsubstituted, branched or linear C ₁-C₂₀ alkenyl groups); wherein X is selected from the group consisting of H, hydrocarbyl groups, and amino and alkylamino groups, i.e., —NH, —NR, —CH₂, —CHR, and —CR₂ groups where R is a C₁-C₂₀ group.

Particular guanidine gas capture moieties may have a formula according to Formula 11:

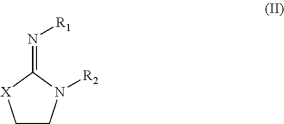

wherein R₁ to R₃ may be the same or different and are selected from H or hydrocarbyl (e.g., selected from the group consisting of substituted or unsubstituted, branched or linear C₁-C₂₀ alkyl groups and substituted or unsubstituted, branched or linear C₁-C₂₀ alkenyl groups); wherein X is selected from the group consisting of hydrocarbyl groups, and alkylamino groups, i.e., —NH, —NR, —CH₂, —CHR, and —CR₂ groups where R is a C₁-C₂₀ group.

Still other gas-capture moieties may have a formula according to Formula (III)

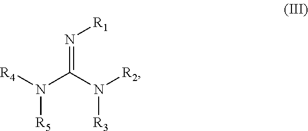

wherein R₁ to R₃ may be the same or different and are selected from H or C₁-C₂₀ hydrocarbyl groups, (e.g., selected from the group consisting of substituted or unsubstituted, branched or linear C₁-C₂₀ alkyl groups and substituted or unsubstituted, branched or linear C₁-C₂₀ alkenyl groups); wherein R₄ and R₅ may be the same or different and are selected from H or C₁-C₂₀ hydrocarbyl groups, (e.g., selected from the group consisting of substituted or unsubstituted, branched or linear C₁-C₂₀ alkyl groups and substituted or unsubstituted, branched or linear C₁-C₂₀ alkenyl groups); wherein any two of R₁-R₅ may be joined to form one or more 5 to 10 member rings.

Certain gas-capture moieties may have a composition according to Formula IV

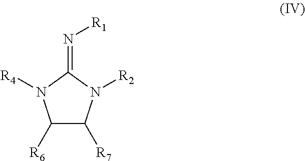

wherein R₆ and R₇ may be the same or different and are selected from H or C₁-C₂₀ hydrocarbyl groups (e.g., selected from the group consisting of substituted or unsubstituted, branched or linear C₁-C₂₀ alkyl groups and substituted or unsubstituted, branched or linear C₁-C₂₀ alkenyl groups). Substituents having 6 or fewer carbon atoms may be beneficial in some cases. Thus, in certain such gas-capture moieties the R₁ links the guanidine compound to the solid support material and is selected from C₂ to C₆ alkyl groups. In certain embodiments, one or more of R₄, R₅ and R₆ are H, particularly all of R₄, R₅ and R₆ are H. In particular gas-capture moieties R₄ is N—C═N—C—R₆.

In particular embodiments, the gas-capture moiety may be a bicyclic compound of the formula according to Formula (V):

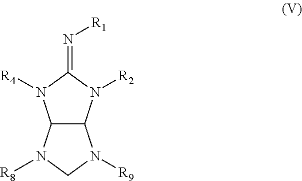

wherein R₈ and R₉ may be the same or different and are selected from H or C₁-C₂₀ hydrocarbyl groups (e.g., selected from the group consisting of substituted or unsubstituted, branched or linear C₁-C₂₀ alkyl groups and substituted or unsubstituted, branched or linear C₁-C₂₀ alkenyl groups), e.g., methyl, ethyl, propyl, butyl, etc. In particular embodiments, each of R₁, R₂, and R₄ are H and R₈ and R₉ are methyl.

Still further gas-capture moieties have a formula according to Formula (VI):

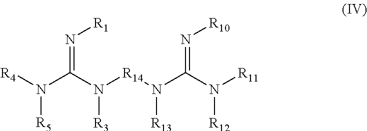

wherein R₁₀-R₁₃ may be the same or different and are selected from H or C₁-C₂₀ hydrocarbyl groups (e.g., selected from the group consisting of substituted or unsubstituted, branched or linear C₁-C₂₀ alkyl groups and substituted or unsubstituted, branched or linear C₁-C₂₀ alkenyl groups), e.g., methyl, ethyl, propyl, butyl, etc.; wherein R₁₄ may be any divalent linking group, particularly a C₁-C₂₀, linear or branched, substituted or unsubstituted alkanediyl group, e.g., —CH₂—, —CH(CH₃)—, C(CH₃)₂—, etc.

Exemplary gas capture moieties include amidine, guanidine, biguanide, 2-amino-2-imidazoline, 2-amino-1-ethyl-imidazoline. One of ordinary skill in the art will readily understand that the compounds and structure described above reflect the active gas-capturing moiety of the compounds and that these materials may be modified in a variety of ways to tether or graft the compound to the support. Thus, the claims should be interpreted accordingly. Such structures are described in more detail below; however, the claims should not be limited to only those tethering or grafting techniques described.

### Combining the Solid Support and the Gas-Capture Moiety

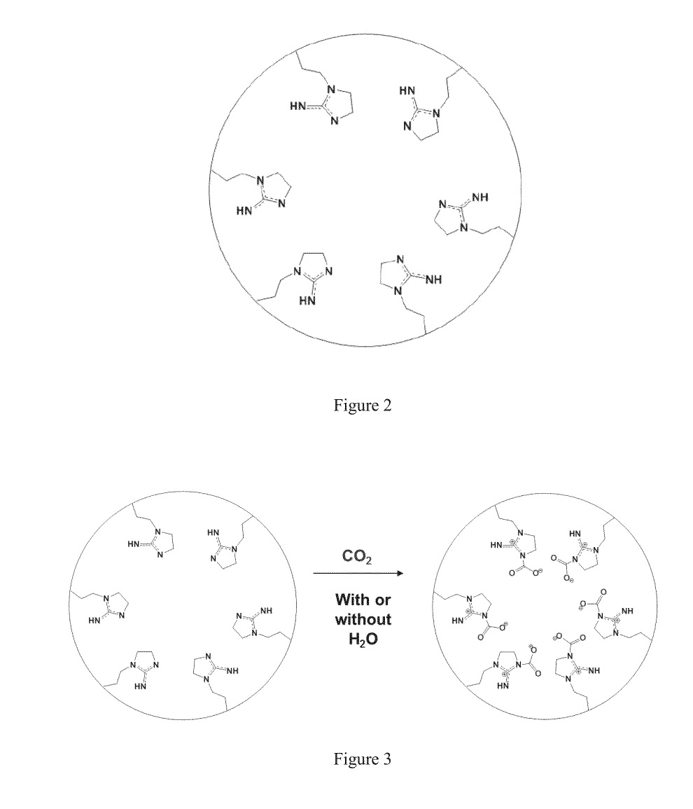

The at least one gas-capture moiety may be combined with the solid support material by any convenient method, typically by attaching the gas-capture moiety to the support via a linking moiety. The linking moiety may be any atom or group of atoms that forms at least one covalent bond with the support material and at least one bond with a gas-capture moiety. The linking moiety may be derived from the gas-capture moiety itself, e.g., via dehydration, deprotonation, etc. Thus, a linking moiety need not be provided as a separate component in the formation of the sorption composition. The linking moiety may also be derived from a site on the solid support, e.g., via deprotonation, etc. Typically, however, a precursor of the gas-capture moiety, e.g., a guanidine, biguanide, etc., is combined with a linking moiety precursor that provides a site for grating onto the support material. Some gas-capture moieties may alternatively be bound to the solid support by including in the gas-capture moiety one or more, preferably one, linking moiety that can react with surface hydroxyls of the support material. Some exemplary linking moieties include propylsilane groups, propylsiloxy group, or longer alkyl or arylalkyl chains, e.g., —CH₂—CH₂₋CH₂—SiH₃, —CH₂—CH₂—CH₂—Si(OEt)₃, or —CH₂—(CH₂)ₙ—SiR₃. Wherein R is any combination of alkoxys, amines and hydrogens and n is 1 to 10. Alternatively, the gas-capture moieties, particularly guanidines, may be tethered to silicas using trimethoxysilyl-propyl and/or glycidol tethers. Gas-capture moieties may be also linked to mesoporous silicas, e.g., MCM-41, by first grafting the surface with the chlorosilane followed by amination with a bicyclic guanidine. Linking moieties and methods of linking gas-capture moieties are described “Guanidines encapsulated in zeolite Y and anchored to MCM-41: synthesis and catalytic activity” by Sercheli, et al., Journal of Molecular Catalysis A: Chemical (Elsevier); vol. 148, Issues 1-2., pp. 173-181 (1999); “Mono- and Bis-N-[3-(triorganylsilyl)propyl]guanidines and Their Derivatives” Russian Journal of General Chemistry, Vol. 73, No. 8, 2003, pp. 1239-1242; U.S. Pat. Nos. 5,252,751; and 8,338,325, each of which is incorporated herein by reference in its entirety. FIG. 2 schematically depicts an exemplary gas-capture moiety chemically attached to the surface of a mesoporous support.

Contacting the Gas Stream with the Sorption Composition

The gas steam may be contacted with the sorption composition in any convenient manner. Upon contact, the gas-capture moieties in the sorption composition sequester the target gas, e.g., in the case of CO₂ the gas-capture moiety reacts with the CO₂ in the gas as shown in Scheme I. Strongly basic gas-capture moieties having high nucleophilicity to CO₂ and unique charge distribution between nitrogens of the gas-capture moieties reacts with CO₂ and forms a zwitterion. Scheme 1 depicts a gas-capture moiety tethered to the surface of the solid support material through an exemplary alkylsilane linking moiety that binds to one or more available oxygen atom of the support. In the case of CO₂, the reaction forms a Zwitterion with the gas-capture moiety. Zwitterion formation is particularly effective when the proposed compound is cyclic, e.g., an imidazoline.

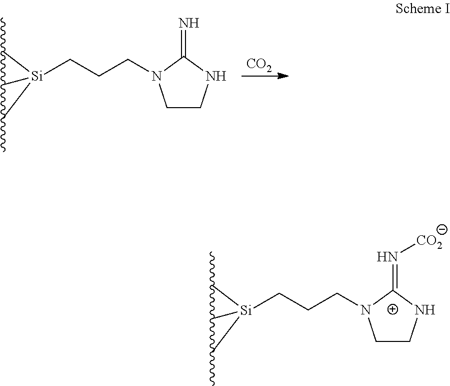

Strongly basic gas-capture moieties having low nucleophilicity to CO₂ preferentially react with H₂S and forms a mercaptide salt as depicted in Scheme 2.

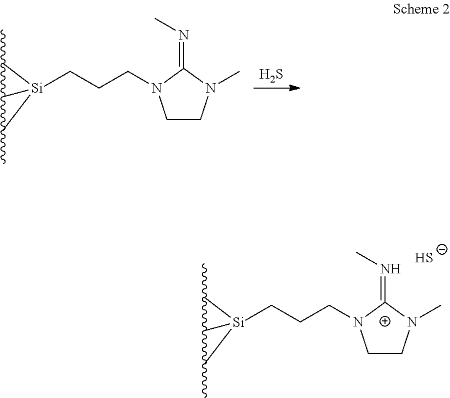

FIG. 3 schematically illustrates Zwitterion formation after exposing an exemplary sorption composition to CO₂. As FIG. 3 indicates the CO₂ may be bound in the gas-capture moiety in the presence or absence of water.

In the case of CO₂ for example, the stability of the CO₂/amine reaction species can be varied by changing Lewis and Brønsted basicity of gas-capture sites. Stability can generally decrease with increasing temperature, so that sorption of the CO₂ can be favored by lower temperatures, but, with operation with flue gas, the temperature can typically be higher, unless the incoming gas stream is initially cooled. With natural gas streams, the temperature can often be lower, particularly if the gas has been passed through an expansion before entering the scrubbing unit. The sorption temperature can typically be at least about 10° C. (e.g., at least about 15° C., at least about 20° C., at least about 25° C., at least about 30° C., at least about 35° C., at least about 40° C., at least about 45° C., at least about 50° C., at least about 55° C., at least about 60° C., at least about 65° C., at least about 70° C., at least about 75° C., or at least about 80° C.) and/or at most about 90° C. (e.g., at most about 85° C., at most about 80° C., at most about 75° C., at most about 70° C., at most about 65° C., at most about 60° C., at most about 55° C., at most about 50° C., at most about 45° C., or at most about 40° C.). In most embodiments, however, a maximum temperature for the sorption can be about 75° C., and, if operation is feasible at a lower temperature (e.g., with a chilled incoming natural gas or refinery process stream), resort may be advantageously made to lower temperatures at this point in the cycle. A sorption temperature of about 70° C. can be a suitable target value for flue gas scrubbing. Temperatures below about 50° C. are likely to be favored for optimal sorption, if capable of attainment at relatively low incremental cost and/or if the incoming gas stream is already at such a temperature; these lower sorption temperatures can be routinely obtainable using a variety of well-known gas stream cooling methods, such as direct contact of a CO₂-containing gas stream with a chilled water spray or an air cooler. Temperatures below about 50° C., such as about 35° C. to about 45° C., are also more suitable for sorption of CO₂ in processes where a precipitate slurry is formed after sorption.

The nature of the gas-capture moieties interaction with the gas to be captured, e.g., CO₂, in any embodiment allows for operation at higher pH than conventional processes, e.g., ≧about 9.5, ≦about 10.0, ≦about 10.5, ≧about 11.0, ≧about 11.5, ≧about 12.0, ≧about 12,5, ≧about 13.0, or ≧about 13.5. Additionally or alternatively, the pH may be ≦14.0, ≦about 13.5, ≦about 13.0, ≦about 12.5, ≦about 12.0, ≦about 11.5, ≦about 11.0, ≦about 10.5, ≦about 10.0, or ≦about 9.8. Ranges expressly disclosed include combinations of any of the above-enumerated upper and lower pH values; e.g., in any embodiment, the pH may be e.g., about 9.5 to 14.0, about 10.0 to 14.0, about 10.5 to 14.0, about 11.0 to 14.0, 11.5 to 14.0, about 12.0 to 14.0, about 12.5 to about 14.0, about 13.0 to 14.0, about 13.5 to 14.0, about 9.5 to about 13.5, about 10.0 to about 13.5, about 10.5 to about 13.5, etc. While reference to pH generally refers to the concentration of protons in aqueous media, one of ordinary skill in the art will understand that pH values herein refer to the pH values determined from pH measurements using a probe calibrated to accurately measure the pH of an aqueous stream, even where the stream from which gas is to be removed is non-aqueous.

Alternatively, it may be convenient to characterize processes and gas-capture moieties described herein by the dissociation constant, expressed as the pKₐ, of the gas-capture moiety. The pKa value of the gas-capture moiety may be about ≧about 9.5, e.g., ≧about 10.0, ≧about 10.5, ≧about 11.0, ≧about 11.5, ≧about 12.0, ≧about 12.5, ≧about 13.0, or ≧about 13.5. Some such gas=capture moieties may have a pKₐ of ≦17.0, e.g., ≦about 15.0, ≦about 14.0, ≦about 13.0, ≧about 12.0, ≦about 11.5, ≦about 11.0, ≦about 10.5, ≦about 10.0, or ≦about 9.8. Ranges expressly disclosed include combinations of any of the above-enumerated upper and lower pKₐ values; e.g., in any embodiment, the pKₐ may be, e.g., about 9.5 to 17.0, about 10.0 to 16.0, about 10.5 to 15.0, about 11.0 to 15.0, 11.5 to 15.0, about 12.0 to 15.0, about 12.5 to about 15.0, about 13.0 to 15.0, about 14.0 to 15.0, etc.

FIG. 2 schematically illustrates an embodiment of the invention wherein the gas-capture moiety chemically attached to the support after exposure to the CO₂-containing stream. In particular embodiments, the gas-capture moiety may be in the form of a solid particulate, typically located in an adsorption bed of the gas-removal unit 104. Additionally or alternatively, the gas-capture moiety may be coated onto the surface of a second solid support, e.g., monolithic solids, where better mass transfer is desired. Additionally or alternatively, the gas-capture moiety may be present as a slurry with which the gas stream is mixed or forced to pass through. Where the gas-capture moiety is present as a slurry, embodiments of the invention may include separating the sorption slurry from the gas stream. One of ordinary skill in the art will readily understand suitable methods for performing such a separation.

The gas stream may be contacted by one or more guard beds comprising the solid support material and the gas-capture moiety. In particular embodiments, the gas stream may be alternately directed between two or more beds to allow continuous operation while one or more beds undergo regeneration.

Embodiments of the invention may also provide for recycling the gas stream to recontact the gas-capture moiety in order to reduce the CO₂ level to the desired concentration.

### Optionally Recovering the Sorbed Gas

The sorbed gas can optionally be desorbed from the sorbent composition by any convenient method, e.g. conventional methods including but not limited to temperature swing, pressure swing, and stripping with an inert (non-reactive) gas stream such as nitrogen, hot C₂, or steam in the regeneration tower. Temperature swing operation can often be a choice in conventional cyclic sorption plants. Typical temperatures in the regeneration zone can be higher than the temperature of the sorption zone. Typically, the desorption temperature is surprisingly low in these systems, e.g., the temperature may be ≦about 75° C., ≦about 65° C., about 55° C., ≦about 50° C., ≦about 45° C.,23 about 40° C., ≦about 35° C., or ≦about 30° C. Additionally or alternatively, the temperature may be ≧about 25° C., ≧about 30° C., ≧about 35° C., ≧about 40° C., ≧about 45° C., ≧about 50° C., ≧about 55° C., ≧about 65° C. Ranges expressly disclosed include combinations of any of the above-enumerated upper and temperature values; e.g., in any embodiment the desorption temperature may be about 25 to about 75° C., about 30 to about 75° C., about 45 to about 75° C., about 50 to about 75° C., about 55 to about 75° C., about 65 to about 75° C., etc. Pressure swing sorption can be less favored in view of the need for recompression; the pressure drop can be determined by the vapor-liquid equilibria at different pressures.

Although the present process can accept water in the entering gas stream, removal of substantial quantities may be desirable when release or regeneration is performed at a temperature below about 100° C., For example, water can be removed by treatment with a drying agent or by cooling to condense water, and thereby to reduce the water content, e.g., so as to avoid an undesirable accumulation of water in an otherwise non-aqueous process. It is also noted that a typical furnace flue gas can contain about 7 wt % carbon dioxide and also about 7 wt % water. This can be approximately a 1:1 ratio, which can provide enough water to hydrate the carbon dioxide to bicarbonate ion without adding extra water and/or without having to remove extra water if regeneration is carried out below about 100° C.

### Particular Embodiments

Embodiment A: A method for separating carbon dioxide from a gas stream, comprising: (a) providing a stream having a gas therein; and (b) contacting the stream with a sorption composition thereby retaining at least a portion of the gas from the stream, the sorption composition comprising: a solid support, a linking moiety, and a gas-capture moiety or a reaction product thereof; wherein the gas-capture moiety has a formula according to Formula (I):

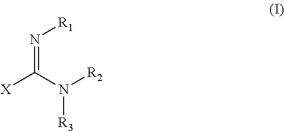

wherein R₁ to R₃ may be the same or different and are selected from H or hydrocarbyl (e.g., selected from the group consisting of substituted or unsubstituted, branched or linear C₁-C₂₀ alkyl groups and substituted or unsubstituted, branched or linear C₁-C₂₀ alkenyl groups);

wherein X is selected from the group consisting of H, hydrocarbyl groups, and amino and alkylamino groups, i.e., —NH, —NR, —CH₂, —CHR, and —CR₂ groups where R is a C₁-C₂₀ group.

Embodiment B: The method of embodiment A, wherein the gas-capture moiety is selected from the group consisting of guanidines, amidines, and biguanides and reaction products thereof.

Embodiment C: The method of Embodiment A or B, wherein the gas-capture moiety has a formula according to Formula (II)

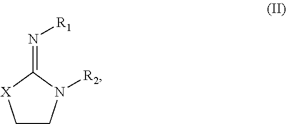

wherein R₁ to R₃ may be the same or different and are selected from H or hydrocarbyl (e.g., selected from the group consisting of substituted or unsubstituted, branched or linear C₁-C₂₀ alkyl groups and substituted or unsubstituted, branched or linear C₁-C₂₀ alkenyl groups);

wherein X is selected from the group consisting of hydrocarbyl groups, and amino groups, i.e., —NH, —NR, —CH₂, —CHR, and —CR₂ groups where R is a C₁-C₂₀ group.

Embodiment D: The method of any of Embodiments A to C, wherein the gas-capture moiety has a formula according to Formula III:

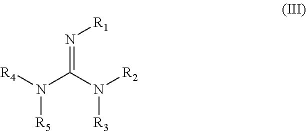

wherein R₁ to R₃ may be the same or different and are selected from H or C₁-C₂₀ hydrocarbyl groups, (e.g., selected from the group consisting of substituted or unsubstituted, branched or linear C₁-C₂₀ alkyl groups and substituted or unsubstituted, branched or linear C₁-C₂₀ alkenyl groups), wherein R₄ and R₅ may be the same or different and are selected from H or C₁-C₂₀ hydrocarbyl groups, (e.g., selected from the group consisting of substituted or unsubstituted, branched or linear C₁-C₂₀ alkyl groups and substituted or unsubstituted, branched or linear C₁-C₂₀ alkenyl groups); wherein any two of R₁-R₅ may be joined to form one or more 5 to 10 member rings.

Embodiment E: The method any of Embodiments A to D, wherein the gas-capture moiety comprises a compound according to Formula (IV):

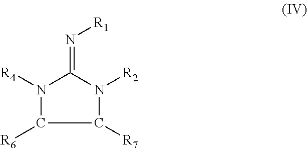

wherein R₆ and R₇ may be the same or different and are selected from H or C₁-C₂₀ hydrocarbyl groups (e.g., selected from the group consisting of substituted or unsubstituted, branched or linear C₁-C₂₀ alkyl groups and substituted or unsubstituted, branched or linear C₁-C₂₀ alkenyl groups), particularly where R₆ and/or R₇ is H.

Embodiment F. The method of any of Embodiments A to E or an independent method, wherein the gas-capture moiety has a formula according to Formula (V):

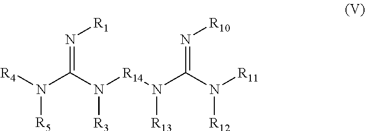

wherein R₁₀-R₁₃ may be the same or different and are selected from H or C₁-C₂₀ hydrocarbyl groups (e.g., selected from the group consisting of substituted or unsubstituted, branched or linear C₁-C₂₀ alkyl groups and substituted or unsubstituted, branched or linear C₁-C₂₀ alkenyl groups), e.g., methyl, ethyl, propyl, butyl, etc.; wherein R₁₄ is selected from C₁-C₂₀, linear or branched, substituted or unsubstituted alkanediyl groups.

Embodiment G: The method of any of Embodiments A to F, further comprising c) recovering at least a portion of the gas from the sorption composition.

Embodiment H: The method of Embodiment G, wherein recovering the gas includes regenerating the sorption composition.

Embodiment I: The method of any of Embodiments A to H wherein, R₁ links the gas-capture moiety to the support material and is selected from C₂ to C₆ alkyl groups, and R₄, R₅ and R₆ are H.

Embodiment J: The method of any of Embodiments A to I, wherein the support material comprises a metal organic framework material, a covalent organic framework material, a porous inorganic framework material, a polymer of intrinsic microporosity or a mixture thereof.

Embodiment K: The method of Embodiment J, wherein the porous inorganic solid comprises a mesoporous silica.

Embodiment L: The method of any of Embodiments A to K, wherein support material comprises MCM-41, MCM-48, SBA-15, or mixtures thereof.

Embodiment M: The method of any of Embodiments A to L, wherein the gas-capture moiety is substantially free of an amine other than the gas-capture moiety or reaction product thereof.

Embodiment N: The method of any of Embodiments A to M, wherein the gas-capture moiety is substantially free of a promoter amine.

Embodiment O: The method of any of Embodiments A to N, wherein one or more of steps a) to c) occur at a pH about 9.5 to about 14, particularly about 10.0 to about 14.0, about 11.0 to about 14.0; about 12.0 to about 14.0; about 13.0 to about 14.0.

Embodiment P: The method of Embodiment G, wherein recovering occurs at a temperature of about 10° C. to about 75° C., preferably about 25° C. to 75° C., about 35° C. to about 75° C., about 45° C. to about 75° C., about 55° C. to about 75° C., about 65° C. to about 75° C.

Embodiment Q: The method of Any of Embodiments A to F, wherein the support material has a Langmuir surface area of about 1800 to about 6000 m²/g, e.g., about 2000 to about 5000 m²/g, about 2500 to about 4500 m²/g, about 3500 to about 4500 m²/g, or about 4000 to about 4500 m²/g.

### Test Methods

Monitoring of CO₂-guanidine reaction chemistry with in-situ NMR

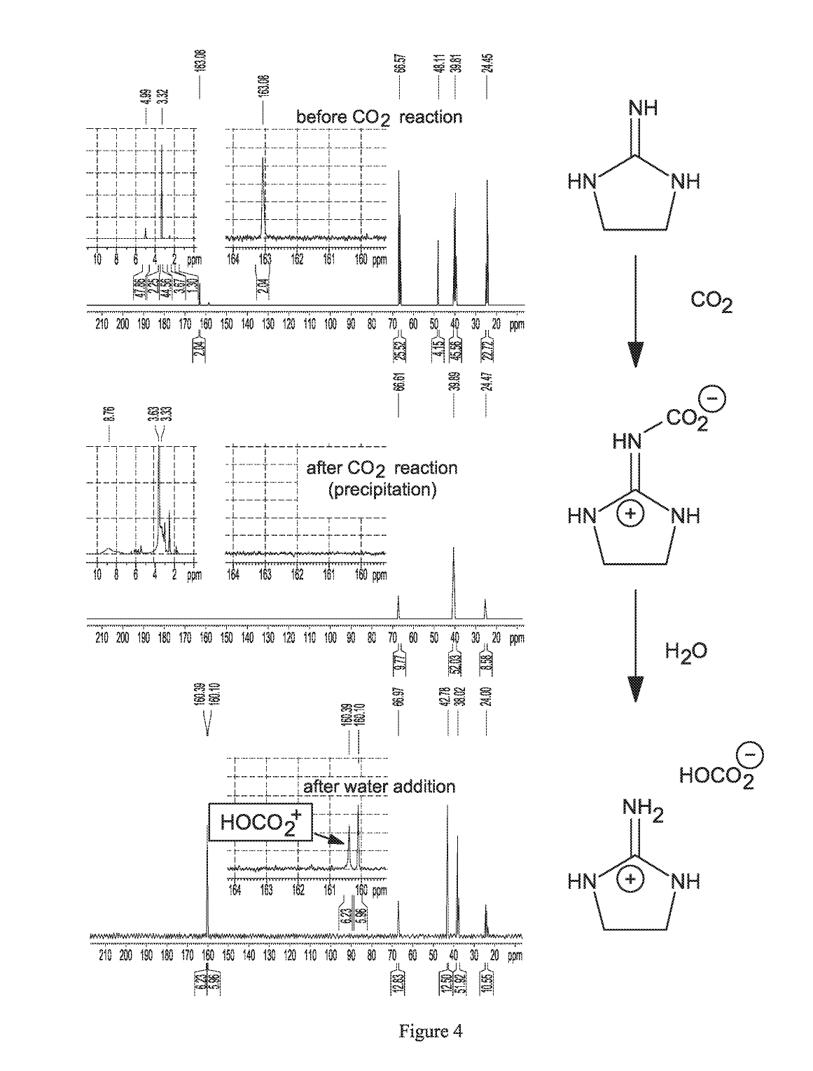

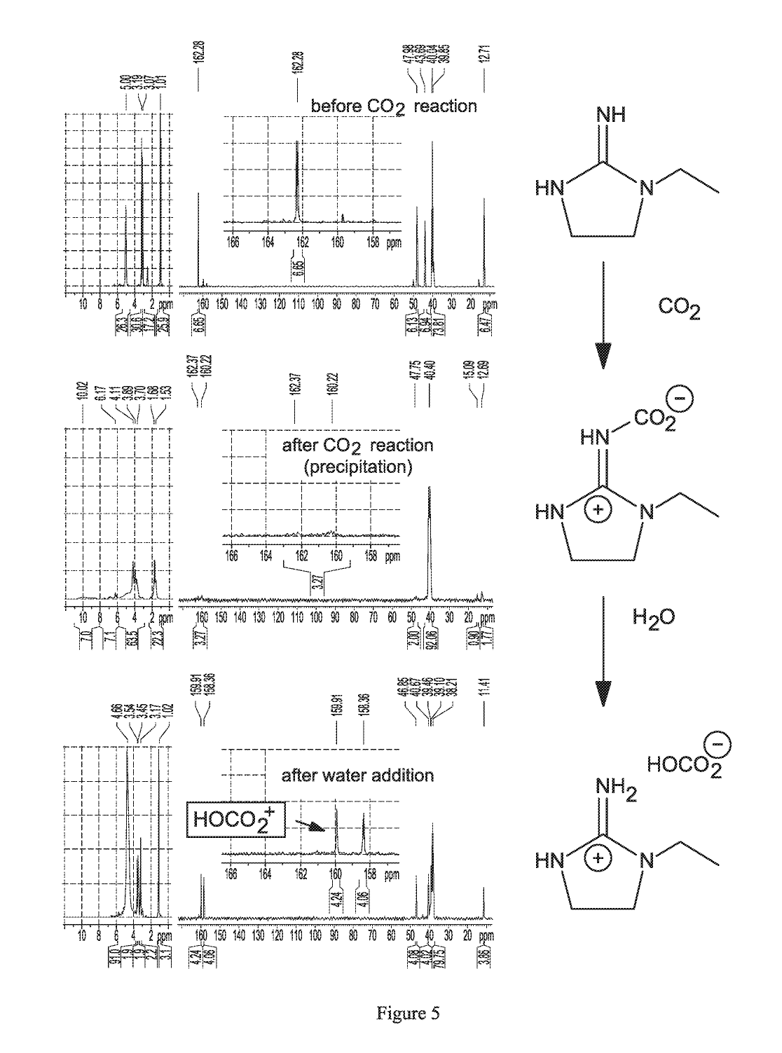

A wide bore 400 MHz Bruker Avance™ NMR spectrometer equipped with variable temperature capabilities is used to study CO₂ reaction with liquid guanidines, which can be incorporated in the structure of porous solid. A 10 mm NMR tube containing a desired guanidine solution (in the range of 1-3 molar) is heated to a chosen temperature and then treated with CO₂-containing gas at a fixed flow rate (typically 10 seem) inside the instrument while recording quantitative ¹H and ¹³C NMR spectra. The experiments at CO₂ partial pressures of 1.0 bar and below are conducted in a flow-through mode (FIG. 4). Gas containing CO₂ (or pure CO₂) is bubbled through the amine solution at a total pressure of about 1.0 bar. Although the majority of experiments reported here are performed by purging pure CO₂ gas (P(CO₂)=1.0 bar), special mixtures of gases are also used to study effects of CO₂ partial pressure. For example, a 10 mol %/90 mol % CO₂/N₂ mixture, purchased from Matheson Tri-Gas, is used to monitor reaction at a CO₂ partial pressure of 0.1 bar.

### Spectral Acquisition

For ¹³C NMR quantitative analysis of the starting solution and final product(s) of CO₂ sorption, a standard single-pulse sequence with proton decoupling (zgig pulse sequence) with repetition delay equal or longer than 60 seconds is used. At least 64 scans are typically taken to generate the ¹³C spectrum. In order to observe intermediate reaction products qualitatively on a short time scale, NOE signal enhancement (zgpg or zgpg30) is used with a shorter repetition delay between 2-5 seconds. Further calibration of ¹³C peak intensities is performed after every reaction on the final reaction products by comparing NMR spectra taken with and without NOE enhancement. For ¹H NMR quantitative analysis of the starting solution, intermediate products, and final products of CO₂ sorption, a single-pulse zg sequence is used with a repetition delay between 10 and 60 seconds. At least 8 scans are typically taken to generate a ¹H spectrum. Manual tuning and matching procedures for the NMR probe are performed between experiments in order to correct impedance changes of ¹³C and ¹H circuits during the reaction caused by the formation of new chemical compounds.

### Spectral Analysis

¹³C and ¹H NMR spectra taken before, during, and after the absorption/desorption sequence(s) gave quantitative information about the starting solution, reaction kinetics, and intermediate/final sorption products. The reaction products seen in ¹³C and ¹H NMR spectra are identified and quantified by integration of the ¹³C NMR carbonyl resonance(s) at 165-155 ppm (representing sorbed CO₂) versus CH₃, —CH₂—, —CH═, etc. resonances representing the —OCH₂CH₂N— and (if present) and —NCH₃ groups of amine to determine the CO₂/amine ratio. ¹H NMR spectra are important to monitor amine concentration in the solvent (guanidine/solvent ratio) as both guanidine and solvent can gradually evaporate in the described flow-through system, especially during the desorption cycle at elevated temperatures.

¹H NMR may give quantitative product information via the splitting of amine backbone resonances (methylene CH₂, etc.) into multiple peaks associated with different CO₂ reaction products. In this study, such methods are not used for quantification of reaction products, since they provide only an indirect measurement whereas ¹³C NMR can directly detect reacted CO₂ and all reaction products. However, in water-free non-aqueous solutions, ¹H NMR provides key information about CO₂-amine reaction products and their evolution and equilibrium.

When desired, samples are transferred into a 5 min NMR tube for more accurate ex-situ 1D and 2D) NMR analysis on a Bruker Avance IIIM narrow bore 400 MHz spectrometer.

### Monitoring of H₂S-guanidine Reaction Chemistry

Measurements of H₂S-guanidine reactions rely on the saturation of an amine solution (located in the reaction vessel at fixed temperature and stirred) by introducing H₂S-containing gas into the reaction vessel and monitoring H₂S concentration in the off-gas with either IR unit or mass spectrometer. Analysis of such H₂S and CO₂ breakthrough curves provide information about uptake, kinetics and H₂S/CO₂ selectivity. Total H₂S and CO₂, uptake can be further measured by running ¹³C and ¹H NMR on the saturated solution. The unit can be operated at high or low pressure by setting upstream and downstream pressure regulators in the desired pressure range. Variation of total gas pressure and selection of gas mixtures of CO₂ in N₂ is used to deliver CO₂ at desired partial pressure from 0.01 bar up to 70 bar. Gas cylinders with either 1% CO₂ in 99% CO₂ in 90% N₂, or 50% CO₂ in 50% N2 are used in the experiments described below.

### EXAMPLES

### Example 1

A CO₂-containing stream is exposed to 5 wt % 2-amino-2-imidazoline dissolved in DMSO-d6 for 1 hour under dry conditions. After the reaction, white powder is observed. Upon addition of water as a second reaction phase, white powder is fully dissolved and NMR detects bicarbonate species with a yield of 95.7 mol % CO₂ per mole of guanidine. Given no CO₂ is added into the solution upon addition of water, 95.7 mol % of CO₂ (per guanidine) is captured in the first reaction phase. Such high CO₂ loading in non-aqueous solution can be explained by formation of either carbamic acid or more likely zwitterion, which precipitates in DMSO-d6 solution and rearranges into soluble bicarbonate in water solution.

The NMR spectra associated with Example 1 are shown in FIG. 4.

### Example 2

A CO₂-containing stream is exposed to 2-amino-1-ethyl-imidazoline for 1 hour under dry conditions. After the reaction, white powder is observed. Upon addition of water as a second reaction phase, white powder is fully dissolved and NMR detects bicarbonate species with a yield of 104 mol % CO₂ per mole of guanidine. Given no CO₂ is added into the solution upon addition of water, 104 mol % of CO₂ (per guanidine) is captured in the first reaction phase. Such high CO₂ loading in non-aqueous solution can be explained by formation of either carbamic acid or more likely zwitterion, which precipitates in DMSO-d6 solution and rearranges into soluble bicarbonate in water solu tion.

### Example 3

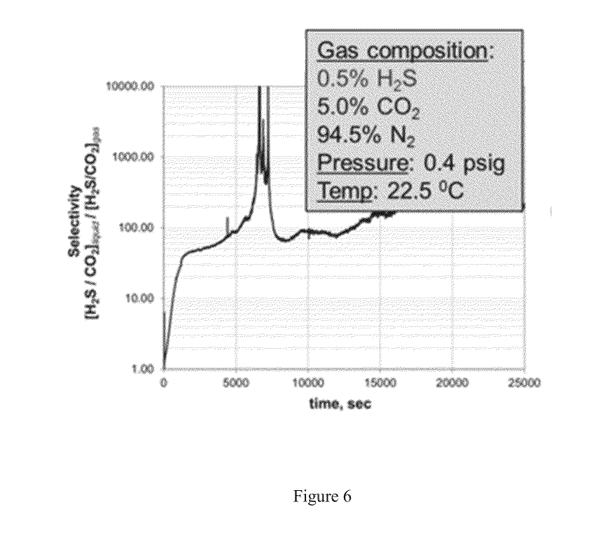

To measure H₂S/CO₂ selectivity with 1,3,3-tetramethylguanidine (TMG), a gas mixture containing 5.0 mol % CO₂ and 0.5% mol % H₂S in N₂ is purged a through reaction vessel with 1 M TMG in DMSO and analyzed off-gas composition as a function of reaction time. FIG. 6 shows concentration of CO₂ and H₂S in the off-gas for two experiments—with and without guanidine in DMSO solution. The difference between these two runs represent the property of TMG to capture CO₂ and H₂S. During the first 1000 seconds, TMG is withdrawing limited amounts of CO₂ while capturing majority H₂S fed to the solution. Resulting H₂S:CO₂ selectivity is approaching 100:1 for first 7 hours of the gas purge.

All documents described herein are incorporated by reference herein for purposes of all jurisdictions where such practice is allowed, including any priority documents and/or testing procedures to the extent they are not inconsistent with this text, provided however that any priority document not named in the initially filed application or filing documents is NOT incorporated by reference herein. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

What is claimed is:

1. A method for separating carbon dioxide from a gas stream, comprising:
a. providing a stream having a gas therein; and
b. contacting the stream with a sorption composition thereby removing at least a portion of the gas from the stream, the sorption composition comprising: a solid support, a linking moiety, and a gas-capture moiety or a reaction product thereof;
wherein the gas-capture moiety has a formula according to Formula (I): 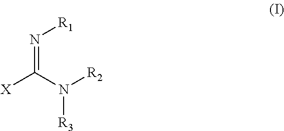
wherein R₁ to R₃ may be the same or different and are selected from H or hydrocarbyl;
wherein X is selected from the group consisting of H, hydrocarbyl groups and amino and alkylamino groups.

2. The method of claim 1, the method of claim 1, wherein the gas-capture moiety is selected from the group consisting of guanidines, amidines, and biguanides and reaction products thereof.

3. The method of claim 1, wherein the gas-capture moiety has a formula according to Formula (II) 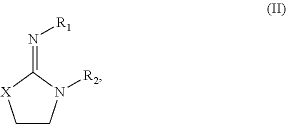
wherein R₁ to R₂ may be the same or different and are selected from H or hydrocarbyl;
wherein X is selected from the group consisting of hydrocarbyl groups, and alkylamino groups.

4. The method of claim 1, wherein the gas-capture moiety has a formula according to Formula III: 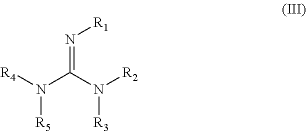
wherein R₁ to R₃ may be the same or diMrc.mt and are selected from H or C₁-C₂₀ hydrocarbyl groups;
wherein R₄ and R₅ may be the same or different and are selected from H or C₁-C₂₀ hydrocarbyl groups, (e.g., selected from the group consisting of substituted or unsubstituted, branched or linear C₁-C₂₀ alkyl groups and substituted or unsubstituted, branched or linear C₁-C₂₀ alkenyl groups);
wherein any two of R₁-R₅ may be joined to form one or more 5 to 10 member rings.

5. The method of claim 3, wherein the gas-capture moiety comprises a compound according to Formula (IV): 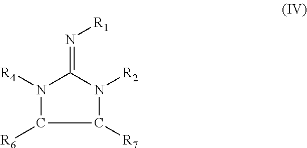
wherein R₆ and R₇ may be the same or different and are selected from H or C₁-C₂₀ hydrocarbyl.

6. The method of claim 1, wherein the gas-capture moiety has a formula according to Formula (V): 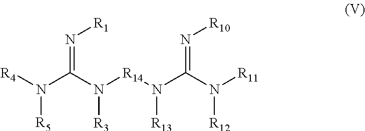
wherein R₁₀-R₁₃ may be the same or different and are selected from H or C₁-C₂₀ hydrocarbyl groups; wherein R₁₄ is selected from C₁-C₂₀, linear or branched, substituted or unsubstituted alkanediyl groups.

7. The method of claim 1, further comprising c) recovering at least a portion of the gas from the sorption composition.

8. The method of claim 7, wherein recovering the gas includes regenerating the sorption composition.

9. The method of claim 7, wherein recovering occurs at a temperature of about 10° C. to about 120° C.

10. The method of claim 1 wherein, R₁ links the gas-capture moiety to the support material and is selected from C₂ to C₆ alkyl groups, and R₄, R₅ and R₆ are H.

11. The method of claim 1, wherein the support material comprises a metal organic framework material, a covalent organic framework material, a porous inorganic framework material, a polymer of intrinsic microporosity or a mixture thereof.

12. The method of claim 10, wherein the support material comprises the porous inorganic framework material, and the porous inorganic framework material comprises a mesoporous silica.

13. The method of claim 1, wherein support material comprises MCM-41, MCM-48, SBA-15, or mixtures thereof.

14. The method of claim 1, wherein the gas-capture moiety is substantially free of an amine other than the gas-capture moiety or reaction product thereof.

15. The method of claim 1, wherein the gas-capture moiety is substantially free of a promoter amine.

16. The method of claim 1 or 8, wherein one or more of steps a) to c) occur at a pH about 9.5 to about 14.

17. The method of claim 1, wherein the support material has a Langmuir surface area of about 1800 to about 6000 m²/g, e.g., about 2000 to about 5000 m²/g, about 2500 to about 4500 m²/g, about 3500 to about 4500 m²/g, or about 4000 to about 4500 m²/g.
